(19) United States
(12) Patent Application Publication
(10) Pub. No.: US 2020/0213744 A1
(43) Pub. Date: Jul. 2, 2020

(54) SPEAKER

(71) Applicant: AAC Technologies Pte. Ltd., Singapore city (SG)

(72) Inventor: Xiaojiang Gu, Shenzhen (CN)

(21) Appl. No.: 16/705,178

(22) Filed: Dec. 5, 2019

(30) Foreign Application Priority Data
Dec. 29, 2018 (CN) 201822269819.4

(51) Int. Cl. H04R 9/02; H04R 9/06

(52) U.S. Cl. CPC H04R 9/025; H04R 2209/041; H04R 9/06

(57) ABSTRACT

A speaker is provided, including a vibration structure, a magnetic circuit structure and a housing including a holder and a front cover. The magnetic circuit structure includes a lower splint, a main magnet, side magnets and an upper splint attached to upper ends of the side magnets. Each side magnet includes an upper end surface facing the upper splint, and a recessed portion recessed from a side of the upper end surface close to the main magnet towards the lower splint. The recessed portion includes a first surface. The upper splint includes a main body portion, a first step portion formed by extending from an edge at the side of the main body portion close to the main magnet while being bent towards the first surface and fixed to the second surface, and a second step portion fixed to the first surface.

### TECHNICAL FIELD

The present disclosure relates to the field of acoustic-electric technologies, and in particular, to a speaker.

### BACKGROUND

With the rapid development of technologies, audio devices also develop rapidly, and functional requirements for audio equipment are getting higher and higher. For speakers, more and more people have put forward higher requirements on their audio performance. In the related art, in order to provide a vibration space for vibration of the voice coil in the vibration structure of the speaker, an upper splint is generally moved down as a whole. Since the upper splint needs to occupy a certain space, a thickness of a side magnet is also reduced as the upper splint is moved down, thereby resulting in a SPL (sound pressure level) loss of the speaker.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded structural schematic view of a speaker according to an embodiment of the present disclosure;

FIG. 2 is an enlarged structural schematic view of a portion B shown in FIG. 1;

FIG. 3 is a top view of the speaker shown in FIG. 1;

FIG. 4 is a cross-sectional view taken along line A-A shown in FIG. 3; and

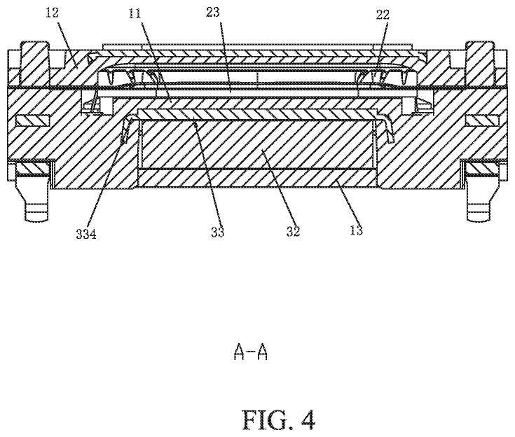

FIG. 5 is a cross-sectional view taken along line B-B shown in FIG. 3.

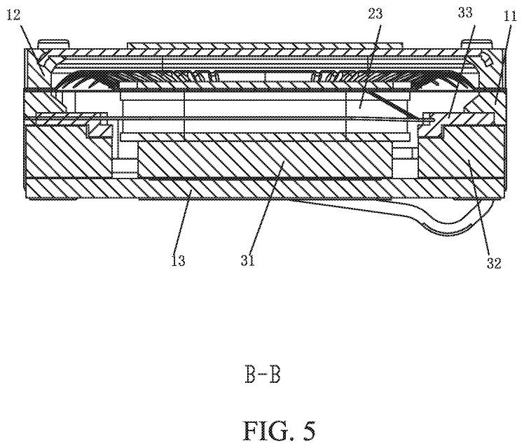

### DESCRIPTION OF EMBODIMENTS

The present disclosure will be further illustrated with reference to the accompanying drawings and the embodiments.

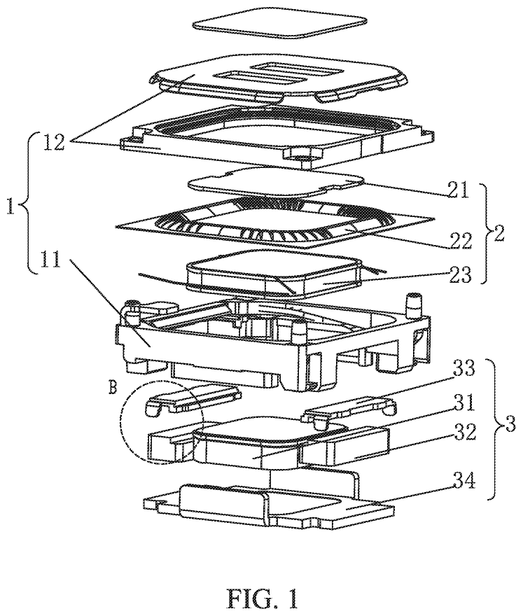

In an embodiment, as shown in FIGS. 1 to 3, a speaker includes a vibration structure 2, a magnetic circuit structure 3, and a housing 1. The housing 1 accommodates the vibration structure 2 and the magnetic circuit structure 3. The housing 1 includes a holder 11 and a front cover 12 that covers and is connected to the holder 11. The magnetic circuit structure 3 is assembled at the bottom of the holder 11. The vibration structure 2 is assembled on the magnetic circuit structure 3. The vibration structure 2 includes a diaphragm 22, a voice coil 23 and a dome 21. The diaphragm 22 is provided between the holder 11 and the front cover 12. The magnetic circuit structure 3 includes a lower splint 34 assembled at the bottom of the holder 11, a main magnet 31 fixed to the lower splint 34, side magnets 32 arranged at two sides of the main magnet 31, and an upper splint 33 attached to upper ends of the side magnets 32. The voice coil 23 is sleeved on the main magnet 31. The dome 21 is provided at an upper end of the diaphragm 22. Each of the side magnets 32 includes an upper end surface 322 facing the upper splint 33, and a recessed portion 321 recessed from a side of the upper end surface 322 close to the main magnet 31 towards the lower splint 34. The recessed portion 321 includes a first surface 323 facing the upper splint 33, and a second surface 324 connecting the first surface 323 with the upper end surface 322. The upper splint 33 includes a main body portion 331 fixed to the upper end surface 322, a first step portion 332, and a second step portion 333. The first step portion 332 is formed by extending from an edge at the side of the main body portion 331 close to the main magnet 31 while being bent towards the first surface 323. The second step portion 333 is formed by extending from the first step portion 332 while being bent towards the main magnet 31. The first step portion 332 is fixed to the second surface 324. The second step portion 333 is fixed to the first surface 323. When the voice coil 23 is energized, the voice coil 23 drives the diaphragm 22 to vibrate and sound under a magnetic field force of the magnetic circuit structure 3. The first step portion 332 and the second step portion 333 of the upper splint 33 make space for vibration of the voice coil 23. Since the side magnet 32 has only the recessed portion 321 correspondingly making way for the first step portion 332 and the second step portion 333 of the upper splint 33, thicknesses of other portions of the side magnet 32 are not reduced, and an overall thickness of the whole magnetic circuit structure 3 is not reduced, so that the SPL loss can be effectively avoided.

In an embodiment, the second surface 324 is parallel with a vibrating direction, and the first step portion 332 extends vertically from a side of the main body portion 331 close to the main magnet 31 towards the first surface 323 along a direction parallel with the vibrating direction. The first surface 323 is perpendicular to the vibrating direction, and the second step portion 333 extends horizontally from the first step portion 332 towards the main magnet 31 along a direction perpendicular to the vibrating direction.

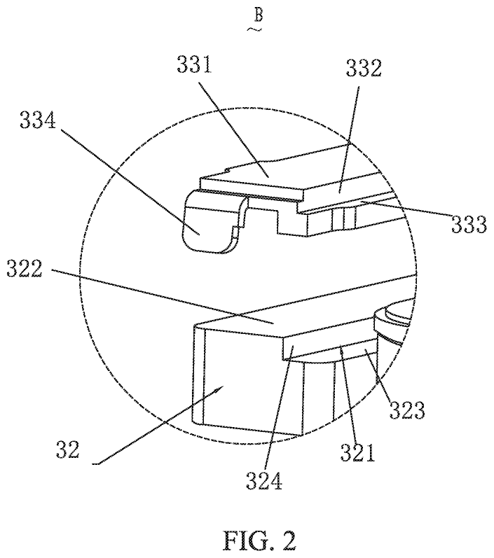

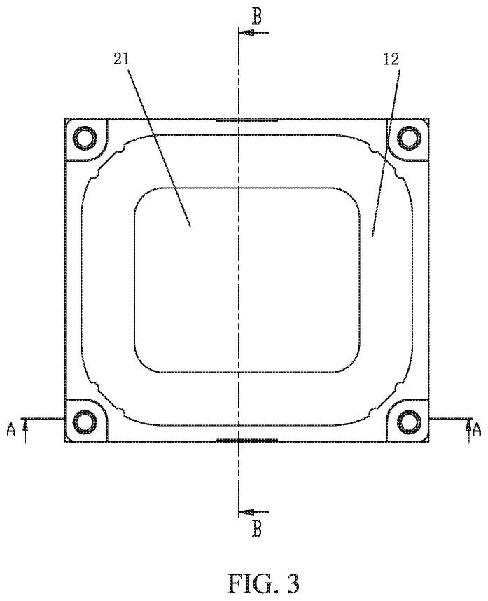

In an embodiment, as shown in FIGS. 2 and 3, embedding portions 334 extending downwards are provided at two sides of the upper splint 33 in a length direction thereof. The embedding portions 334 are inserted into an inner wall of the holder 11 to limit the side magnets 32, so that the displacement of the side magnets 32 is avoided, thereby ensuring the stability of the magnetic circuit structure 3. In other embodiments, the upper splint 33 can also be integrally injection-molded with the holder 11. In an embodiment, one main magnet 31 is provided, and two side magnets 32 are provided correspondingly at two opposite sides of the main magnet 31. In an embodiment, the side magnets 32 are symmetrically arranged about a central axis of the main magnet 31. Accordingly, the upper splint 33 is also symmetrically arranged about the central axis of the main magnet 31. In other embodiments, the magnetic circuit structure 3 may also be a magnetic circuit structure having multiple sets of magnetic circuits.

The above are merely embodiments of the present disclosure. Here, it should be noted that those skilled in the art can make modifications without departing from the inventive concept of the present disclosure, but these shall fall into the protection scope of the present disclosure.

What is claimed is:

1. A speaker, comprising:
a vibration structure;
a magnetic circuit structure; and
a housing receiving the vibration structure and the magnetic circuit structure,
wherein the housing comprises a holder and a front cover, and the magnetic circuit structure comprises a lower splint assembled at a bottom of the holder, a main magnet fixed to the lower splint, side magnets arranged at two sides of the main magnet, and an upper splint attached to upper ends of the side magnets,
wherein each of the side magnets comprises an upper end surface facing the upper splint, and a recessed portion formed by recessing from a side of the upper end surface close to the main magnet towards the lower splint, the recessed portion comprises a first surface facing the upper splint and a second surface connecting the first surface with the upper end surface, the upper splint comprises a main body portion fixed to the upper end surface, a first step portion formed by extending from an edge at a side of the main body portion close to the main magnet while being bent towards the first surface, and a second step portion formed by extending from the first step portion while being bent towards the main magnet, the first step portion is fixed to the second surface, and the second step portion is fixed to the first surface.

2. The speaker as described in claim 1, wherein the second surface is parallel with a vibrating direction, and the first step portion extends vertically from the side of the main body portion close to the main magnet towards the first surface along a direction parallel with the vibrating direction.

3. The speaker as described in claim 2, wherein the first surface is perpendicular to the vibrating direction, and the second step portion extends horizontally from the first step portion towards the main magnet along a direction perpendicular to the vibrating direction.

4. The speaker as described in claim 1, wherein embedding portions extending downwards are provided at two sides of the upper splint in a length direction, and the embedding portions are inserted into an inner wall of the holder.

5. The speaker as described in claim 4, wherein one main magnet is provided, and two side magnets are provided correspondingly at two opposite sides of the one main magnet.

6. The speaker as described in claim 5, wherein the upper splint is symmetrically arranged about a central axis of the main magnet.
